(19) United States
(12) Patent Application Publication
(10) Pub. No.: US 2025/0167835 A1
(43) Pub. Date: May 22, 2025

(54) METHOD FOR MACHINE-LEARNING-BASED UPLINK CHANNEL ESTIMATION IN REFLECTIVE INTELLIGENT SYSTEMS

(71) Applicant: Nokia Solutions and Networks Oy, Espoo (FI)

(72) Inventors: Wissam OBEID, Bures Sur Yvette (FR); Pavan KOTESHWAR SRINATH, Massy (FR)

(21) Appl. No.: 18/838,552

(22) PCT Filed: Feb. 22, 2022
(86) PCT No.: PCT/US2022/017288

§ 371 Date: Aug. 14, 2024

(51) Int. Cl. H04B 7/04; H04L 25/02

(52) U.S. Cl. CPC H04B 7/04013; H04L 25/0256

(57) ABSTRACT

An apparatus includes at least one processor; and at least one memory including computer program code; wherein the at least one memory and the computer program code are configured to, with the at least one processor, cause the apparatus at least to: train a machine learning model to learn a configuration matrix that defines a reconfigurable intelligent surface; configure the reconfigurable intelligent surface for channel estimation during runtime, using the learned configuration matrix; perform channel estimation on an uplink channel using the reconfigurable intelligent surface; and reconfigure the reconfigurable intelligent surface after the channel estimation to improve coverage within the uplink channel.

### TECHNICAL FIELD

The examples and non-limiting embodiments relate generally to communications and, more particularly, to a method for machine-learning-based uplink channel estimation in reflective intelligent systems.

### BACKGROUND

It is known to reflect signals in a communication network.

### SUMMARY

In one aspect, an apparatus includes at least one processor; and at least one memory including computer program code; wherein the at least one memory and the computer program code are configured to, with the at least one processor, cause the apparatus at least to: train a machine learning model to learn a configuration matrix that defines a reconfigurable intelligent surface; configure the reconfigurable intelligent surface for channel estimation during runtime, using the learned configuration matrix; perform channel estimation on an uplink channel using the reconfigurable intelligent surface; and reconfigure the reconfigurable intelligent surface after the channel estimation to improve coverage within the uplink channel.

In another aspect, a method includes training a machine learning model to learn a configuration matrix that defines a reconfigurable intelligent surface; configuring the reconfigurable intelligent surface for channel estimation during runtime, using the learned configuration matrix; performing channel estimation on an uplink channel using the reconfigurable intelligent surface; and reconfiguring the reconfigurable intelligent surface after the channel estimation to improve coverage within the uplink channel.

In another aspect, an apparatus includes means for training a machine learning model to learn a configuration matrix that defines a reconfigurable intelligent surface; means for configuring the reconfigurable intelligent surface for channel estimation during using runtime, the learned configuration matrix; means for performing channel estimation on an uplink channel using the reconfigurable intelligent surface; and means for reconfiguring the reconfigurable intelligent surface after the channel estimation to improve coverage within the uplink channel.

In another aspect, a non-transitory program storage device readable by a machine, tangibly embodying a program of instructions executable with the machine for performing operations is provided, the operations comprising: training a machine learning model to learn a configuration matrix that defines a reconfigurable intelligent surface; configuring the reconfigurable intelligent surface for channel estimation during runtime, using the learned configuration matrix; performing channel estimation on an uplink channel using the reconfigurable intelligent surface; and reconfiguring the reconfigurable intelligent surface after the channel estimation to improve coverage within the uplink channel.

### BRIEF DESCRIPTION OF THE DRAWINGS

The foregoing aspects and other features are explained in the following description, taken in connection with the accompanying drawings.

FIG. 1 is a block diagram of one possible and non-limiting system in which the example embodiments may be practiced.

FIG. 2 depicts an example RIS/IRS configuration.

FIG. 3 illustrates RIS improving coverage in a communication network.

FIG. 4 depicts RIS geometry.

FIG. 5 is a flowchart of the herein described technique for channel estimation.

FIG. 6 is a plot showing received power by the BS versus distance with the linear regression model.

FIG. 7 is a plot showing NMSE versus SNR for Q=50, where Q corresponds to the number of time instants.

FIG. 8 is a plot showing NMSE versus SNR for Q=32, where Q corresponds to the number of time instants.

FIG. 9 is an example apparatus configured to implement the examples described herein.

FIG. 10 is an example method to implement the examples described herein.

### DETAILED DESCRIPTION OF EXAMPLE EMBODIMENTS

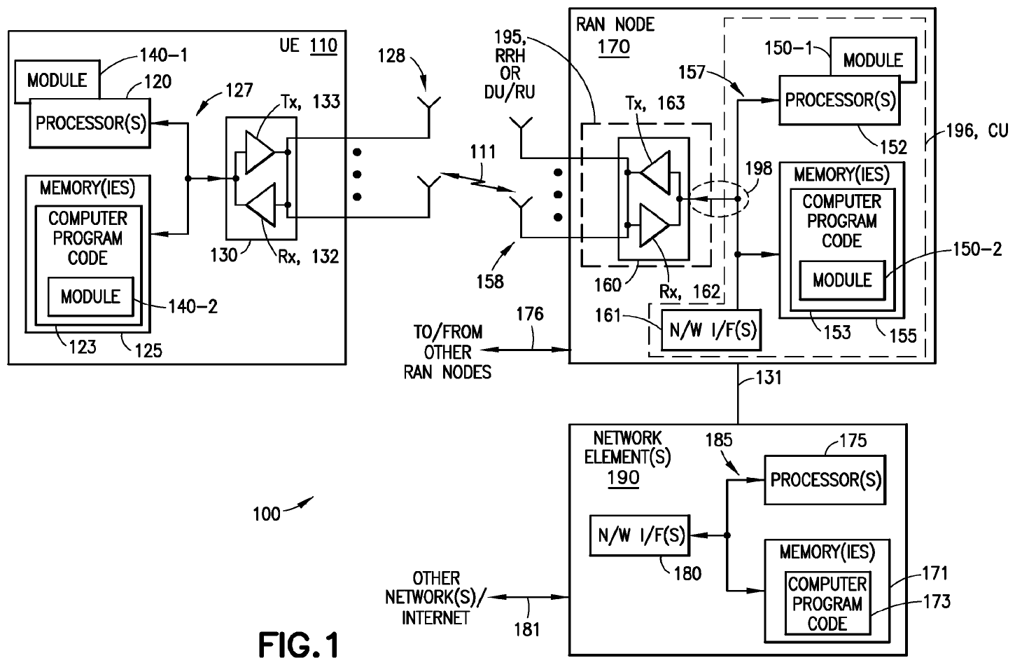

Turning to FIG. 1, this figure shows a block diagram of one possible and non-limiting example in which the examples may be practiced. A user equipment (UE) 110, radio access network (RAN) node 170, and network element(s) 190 are illustrated. In the example of FIG. 1, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The RAN node 170 in this example is a base station that provides access by wireless devices such as the UE 110 to the wireless network 100. The RAN node 170 may be, for example, a base station for 5G, also called New Radio (NR). In 5G, the RAN node 170 may be a NG-RAN node, which is defined as either a gNB or an ng-eNB. A gNB is a node providing NR user plane and control plane protocol terminations towards the UE, and connected via the NG interface (such as connection 131) to a 5GC (such as, for example, the network element(s) 190). The ng-eNB is a node providing E-UTRA user plane and control plane protocol terminations towards the UE, and connected via the NG interface (such as connection 131) to the 5GC. The NG-RAN node may include multiple gNBs, which may also include a central unit (CU) (gNB-CU) 196 and distributed unit(s) (DUs) (gNB-DUs), of which DU 195 is shown. Note that the DU 195 may include or be coupled to and control a radio unit (RU). The gNB-CU 196 is a logical node hosting radio resource control (RRC), SDAP and PDCP protocols of the gNB or RRC and PDCP protocols of the en-gNB that control the operation of one or more gNB-DUs. The gNB-CU 196 terminates the F1 interface connected with the gNB-DU 195. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU 195 is a logical node hosting RLC, MAC and PHY layers of the gNB or en-gNB, and its operation is partly controlled by gNB-CU 196. One gNB-CU 196 supports one or multiple cells. One cell may be supported with one gNB-DU 195, or one cell may be supported/shared with multiple DUs under RAN sharing. The gNB-DU 195 terminates the F1 interface 198 connected with the gNB-CU 196. Note that the DU 195 is considered to include the transceiver 160, e.g., as part of a RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station or node.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, memory(ies) 155, and network interfaces 161. Note that the DU 195 may also contain its own memory/memories and processor(s), and/or other hardware, but these are not shown.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, e.g., link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU 195, and the one or more buses 157 could be implemented in part as, for example, fiber optic cable or other suitable network connection to connect the other elements (e.g., a central unit (CU), gNB-CU 196) of the RAN node 170 to the RRH/DU 195. Reference 198 also indicates those suitable network link(s).

It is noted that the description herein indicates that “cells” perform functions, but it should be clear that equipment which forms the cell may perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (e.g., the Internet). Such core network functionality for 5G may include location management functions (LMF(s)) and/or access and mobility management function(s) (AMF(S)) and/or user plane functions (UPF(s)) and/or session management function(s) (SMF(s)). Such core network functionality for LTE may include MME (Mobility Management Entity)/SGW (Serving Gateway) functionality. Such core network functionality may include SON (self-organizing/optimizing network) functionality. These are merely example functions that may be supported by the network element(s) 190, and note that both 5G and LTE functions might be supported. The RAN node 170 is coupled via a link 131 to the network element 190. The link 131 may be implemented as, e.g., an NG interface for 5G, or an S1 interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, non-transitory memory, transitory memory, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, network element(s) 190, and other functions as described herein.

In general, the various embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, head mounted displays such as those that implement virtual/augmented/mixed reality, as well as portable units or terminals that incorporate combinations of such functions.

UE 110, RAN node 170, and/or network element(s) 190, (and associated memories, computer program code and modules) may be configured to implement (e.g. in part) the methods described herein, including a method for machine-learning-based uplink channel estimation in reflective intelligent systems. Thus, computer program code 123, module 140-1, module 140-2, and other elements/features shown in FIG. 1 of UE 110 may implement user equipment related aspects of the methods described herein. Similarly, computer program code 153, module 150-1, module 150-2, and other elements/features shown in FIG. 1 of RAN node 170 may implement gNB/TRP related aspects of the methods described herein. Computer program code 173 and other elements/features shown in FIG. 1 of network element(s) 190 may be configured to implement network element related aspects of the methods described herein.

Having thus introduced a suitable but non-limiting technical context for the practice of the example embodiments, the example embodiments are now described with greater specificity.

In communications systems beyond 5G, the possibility of controlling the propagation channel is under consideration. A new technology has been spotted in this context which is based on reconfigurable intelligent surfaces (RIS), or intelligent reflective surfaces (IRS), used interchangeably. These surfaces are formed of passive (i.e., do not generate energy but only redirect energy that is incident on them) electromagnetic materials that are controlled by integrated electronics and are used to tune the signal reflection smartly in a way that changes the communication channel to be more reliable and also improves coverage. So, by densely deploying RIS in wireless networks and smartly coordinating their reflections, the wireless channels between transmitters and receivers can be flexibly reconfigured to achieve desired realizations. However, before carrying out this reconfiguration, a channel estimation of the cascaded Tx->RIS->Rx channel is needed.

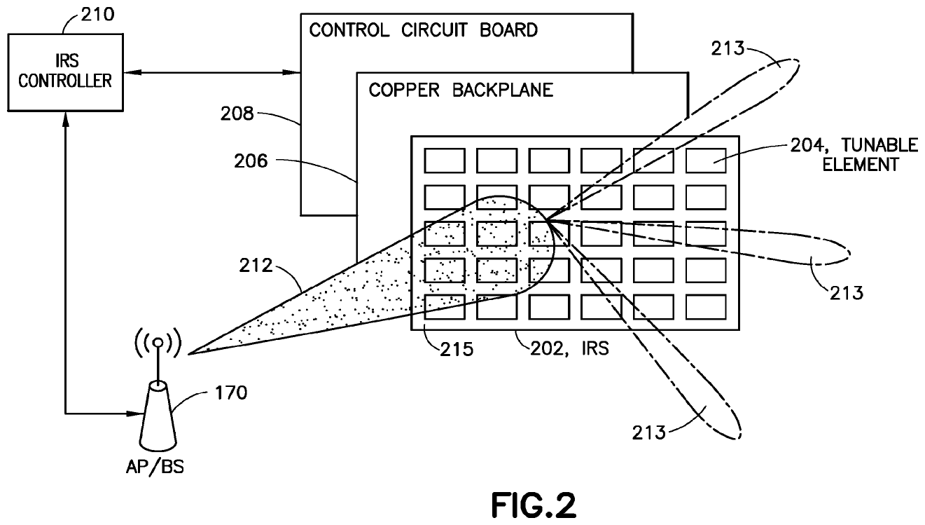

FIG. 2 illustrates an examples RIS/IRS configuration. The AP/BS 170 transmits a beam 212 to the IRS 202, which beam 212 is reflected by the IRS causing reflections 213. The IRS 202 includes a plurality of tunable elements 204, a copper backplane 206, and a control circuit board 208. The IRS controller 210 transmits control signaling to and receives signaling from the AP/BS 170. The IRS controller 210 also transmits control signaling to and receives signaling from IRS 202 via the control circuit board 208. The IRS/RIS 202 is a physical device and its configuration can be measured.

The examples described herein concern the determination of an appropriate method to perform uplink channel estimation in an RIS-based communication system with reasonable complexity and lower percentage of pilots overhead.

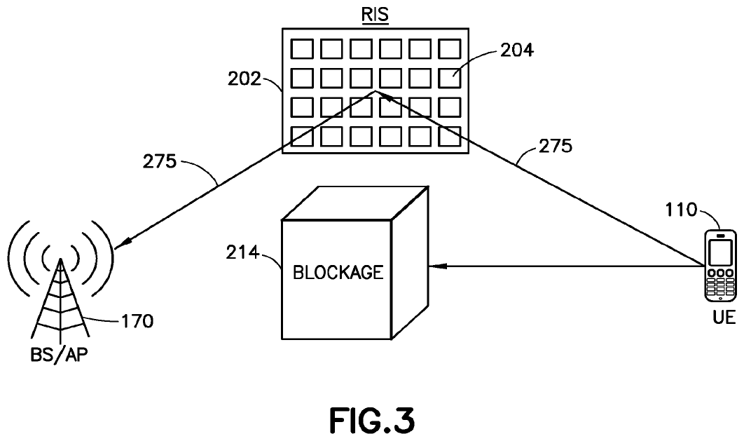

FIG. 3 shows how RIS 202 can be used to improve coverage. The tunable elements 204 of the RIS 202 are used to configure the channel (including uplink channel 275) in a way that is favorable for data transmission from the UE 110 to the BS/AP 170. However, the RIS configuration is only possible after first performing channel estimation (of the overall cascaded channel from the UE 110 to the RIS 202 to the BS 170). This is a huge challenge because the RIS elements 204 are passive by nature and they do not contain any RF part. This means that the RIS elements 204 do not send pilot signals by themselves. In order to have accurate channel estimation at the base station 170, the number of channel coefficients to be estimated is directly proportional to the number of RIS elements 204 which induces a massive overhead and is a significant factor that could limit the usage of this technology. The examples described herein concern a machine-learning based method to reduce the overhead involved in channel estimation. As further shown in FIG. 3, the blockage 214 obstructs the signal from the UE 110 to the BS/AP 170, where the RIS 202 facilitates signal transmission from the UE 110 to the BS/AP 170, improving coverage.

RIS has recently appeared in the field of wireless communications. The common feature of the RIS is that the surface 215 (referring to FIG. 2) consists of many discrete elements with controllable properties. The main focus is on filtering the signal by potentially incurring some time delays in order to increase the constructive interference at the receiver (162). However, in order to do this filtering, channel estimation is the mandatory initial step and that is a real challenge.

In the field of RIS channel estimation, a technique is to apply complex mathematical approaches like sparse matrix factorization followed by matrix completion (e.g. for metasurfaces), and parallel factor decomposition (e.g. in ris-assisted multi-user miso communication). Another technique is to assume a few active elements on the RIS 202 and use compressed sensing with deep learning to estimate the channel, including for compressive sensing, millimeter wave and massive MIMO systems, denoising neural network assistance, and mmwave intelligent reflecting surfaces. However, the point of using RIS is to improve coverage using passive elements only, and attaching a few RF chains to them is not totally feasible.

The two most significant channel estimation techniques are zero-forcing based and single emphasis on rank one matrix (SEROM). The overhead is massive for zero-forcing based techniques, and the channel estimation error a little high for SEROM.

Machine learning is being widely deployed to significantly improve the state-of-the-art in a range of different disciplines. Indeed, machine learning and artificial intelligence based methods have started to be implemented in wireless systems and especially in newer technologies, e.g. for channel estimation and signal detection in OFDM systems. Thus, machine learning based methods are promising options with regards to reducing the pilot overhead in RIS-channel estimation.

All state-of-the-art channel-estimation techniques that do not use active elements at the RIS use a two step approach in order to improve coverage and use RIS intelligently (steps 1-2 immediately following).
1) Use a predefined matrix (usually a full DFT matrix (e.g. for signal processing) or a truncated DFT matrix (e.g. for phase shift design for a MIMO system)) that defines the RIS configuration during the channel estimation stage. Using this predefined RIS configuration, perform channel estimation of the cascaded uplink channel UE->RIS->BS. The overhead is defined by the size of the matrix used.
2) After channel estimation, intelligently reconfigure the RIS 202 in order to improve coverage or maximize received SNR at the receiver (162, 170).

The herein described technique can be summarized as follows.
1) Pre-train a machine-learning model to learn the matrix that defines the RIS configuration in the channel estimation phase. This ML-model attempts to learn the most suitable RIS configuration for the wireless radio environment in context with the goal of keeping the overhead as low as possible while meeting a target normalized mean-square error (NMSE) for the channel coefficient estimates.
2) At run-time, use the learned matrix to configure the RIS for channel estimation.

The advantage of the herein described technique is an improved channel estimation with reduced overhead compared to SEROM (e.g. for channel estimation and phase shift design for an intelligent reflecting surface MIMO system).

### 1. Channel Model

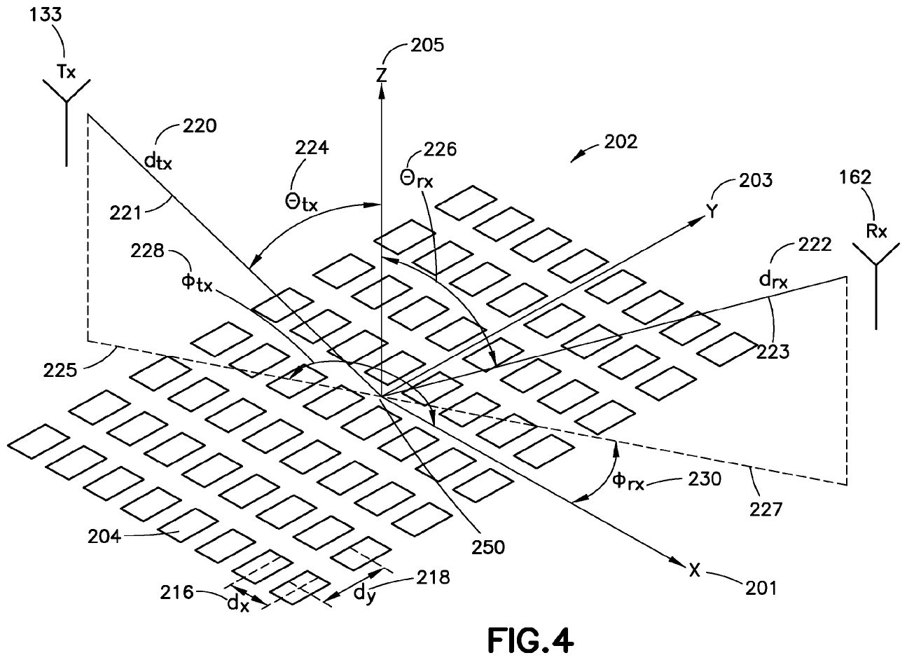

In FIG. 4, the considered RIS geometry is shown. It is assumed that the RIS 202 consists of L=LₓL_{y} tunable elements 204, where Lₓ and L_{y} are the number of columns (x-axis) and rows (y-axis) respectively in the RIS 204. In FIG. 4, Lₓ=8 and L_{y}=8. An element 204 is indexed by the pair ( [symbol] _{y}, [symbol] ₓ), where [symbol] _{y} indicates the element index on the y-axis relative to the center, and [symbol] ₓ indicates the same on the x-axis. So,

$${ℓ}_{x} = - \frac{- {L}_{x}}{2} + 1 , … , \frac{{L}_{x}}{2} , and {ℓ}_{y} = - \frac{- {L}_{y}}{2} + 1 , … , \frac{{L}_{y}}{2} .$$

The transmitter (Tx 133), the RIS 202, and the receiver (Rx 162) are located far enough from each other so that the far-field approximation holds.

Further shown in FIG. 4 is x-axis 201, y-axis 203, and z-axis 205. The term dₓ 216 corresponds to the distance between midpoints of the tunable elements 204 along the x-axis 201, and the term d_{y} 218 corresponds to the distance between midpoints of the tunable elements 204 along the y-axis 203. The term dₜₓ 220 corresponds to the distance between the transmitter 133 (of e.g. UE 110 and the center 250 of the RIS 202, and the term dᵣₓ 222 corresponds to the distance between the center 250 of the RIS and the receiver 162 (e.g. of network node 170). The term θₜₓ 224 corresponds to the angle between a projection 221 from the center 250 of the RIS 202 to the transmitter 133 and the z-axis 205, and the term θᵣₓ 226 corresponds to the angle between a projection 223 from the center 250 of the RIS 202 to the receiver 162 and the z-axis 205. The term ϕₜₓ 228 corresponds to the angle between a horizontal portion 225 of the projection 221 and the x-axis 201, and the term ϕᵣₓ 230 corresponds to the angle between a horizontal portion 227 of the projection 223 and the x-axis 201.

The total RIS delay [symbol] for element 204 indexed by ( [symbol] _{y}, [symbol] ₓ) is calculated by considering the difference of distance traveled between the wavefront that: 1) impinges on the center of the RIS 202 and the one that impinges the element ( [symbol] _{y}, [symbol] ₓ), and 2) is reflected by the center of the RIS and the one that is reflected from the element ( [symbol] _{y}, [symbol] ₓ).

The propagation delay τ^{prop} is computed relative to a virtual LOS between the BS 170 and the UE 110. The end-to-end delay is:

$${τ}_{ℓ}^{E 2 E} = {τ}^{prop} + {τ}_{ℓ}^{RIS} , ℓ = 1 , … , L .$$

The discrete time impulse response for each tap m∈M is:

$$h [ m ] = {\sum }_{ℓ = 1}^{L} \sqrt{{α}_{ℓ} {β}_{ℓ}} {e}^{- j 2 π {f}_{c} {τ}_{ℓ}^{E 2 E}} {e}^{- j 2 π {f}_{c} {τ}_{{ϕ}_{ℓ}}} sin c ( m - B {τ}_{ℓ}^{E 2 E} )$$

where B is the signal bandwidth, [symbol] the adjustable phase shift done by the RIS element [symbol] and [symbol] the induced delay, and [symbol] is the product of the cascaded channel power (which is calculated using the Quadriga channel simulator for simulation purposes that is explained further herein).

After some manipulation over the discrete time impulse response expression, one can obtain a compact expression of the channel function as an inner product of vₘ∈ [symbol] ^{L×1}, the cascaded channel Tx (110/133)->RIS (202) and RIS (202)->Rx (170/162), and ζ[t]∈ [symbol] ^{L×1}, the controllable phase shift of the RIS 202 at time instant t.

$$h [ m ] = {\underbrace{{[ \begin{matrix}\sqrt{{α}_{1} {β}_{1}} {e}^{- j 2 π {f}_{c} {τ}_{1}^{E 2 E}} sin c ( m - B {τ}_{1}^{E 2 E} ) \\ ⋮ \\ \sqrt{{α}_{L} {β}_{L}} {e}^{- j 2 π {f}_{c} {τ}_{1}^{E 2 E}} sin c ( m - B {τ}_{L}^{E 2 E} )\end{matrix} ]}^{T}}}_{{v}_{m}^{T}} {\underbrace{[ \begin{matrix}{e}^{- j 2 π {f}_{c} {τ}_{{ϕ}_{1} [ t ]}} \\ ⋮ \\ {e}^{- j 2 π {f}_{c} {τ}_{{ϕ}_{ℓ} [ t ]}}\end{matrix} ]}}_{ζ [ t ]}$$

with

$${ϕ}_{ℓ} [ t ] ∈ \{ 0 , \frac{2 π}{{2}^{{N}_{B}}} , … , \frac{( {2}^{{N}_{B}} - 1 ) 2 π}{{2}^{{N}_{B}}} \} .$$

Here, N_{B} is the number of used bits for phase.

Now if the vectors vₘ for all the M taps are gathered in one matrix V:=[v₀, . . . , v_{M-1}]∈ [symbol] ^{L×M}, the channel response at time instant t is able to be written as:

$$[ \begin{matrix}h [ 0 ] \\ ⋮ \\ h [ M - 1 ]\end{matrix} ] = {V}^{T} ζ [ t ] .$$

Therefore, when a sequence of T pilot signals s_{UL}[1], s_{UL}[2], . . . s_{UL}[T] are transmitted, the signal model can be written as

$${Y}_{UL} = {V}^{T} Ω P + {N}_{UL} \qquad ( 1 )$$

where Y_{UL}∈ [symbol] ^{M×T} is the received signal, Ω [symbol] [ζ[1], . . . , ζ[T]]∈ [symbol] ^{L×T} is the RIS configuration matrix, P [symbol] diag[s_{UL}[1], s_{UL}[2], . . . s_{UL}[T]]∈ [symbol] ^{T×T}, and N_{UL}∈ [symbol] ^{M×T} is the AWGN matrix. Note that channel estimation refers to estimating the matrix V which is assumed to be constant over the T time instants.

### 2. Considered Baselines

### 2.1 Zero Forcing

The received signal is: Y_{UL}=V^{T}Ω_{ZF}s_{UL}+N_{UL} with Ω_{ZF}=[ζ[1], . . . , ζ[L]]∈ [symbol] ^{L×L} being a DFT matrix, and s_{UL} is a (known) unit energy pilot signal. The zero-forcing estimate of V^{T} is s_{UL}*Y_{UL}Ω_{ZF}^{H}. This method requires a training period of L time instants.

### 2.2 Single Emphasis on Rank One Matrix (SEROM)

The received signal is: Y_{UL}=V^{T}Ωₛₑᵣₒₘs_{UL}+N_{UL} with Ωₛₑᵣₒₘ=[ζ[1], . . . , ζ[Q]]∈ [symbol] ^{L×Q} being the RIS configuration matrix, and s_{UL} is a (known) pilot signal. The estimate of V^{T} is

$${s}_{UL}^{*} {Y}_{UL} {Ω}_{serom}^{H} diag [ {a}_{1} , {a}_{2} , … , {a}_{L} ] \qquad ( 2 )$$

where α₁, α₂, . . . , α_{L} are scaling factors used to cancel the effect of ΩₛₑᵣₒₘΩₛₑᵣₒₘ^{H} which is not an identity matrix owing to Ωₛₑᵣₒₘ being a truncated DFT matrix.

The precise value of αᵢ is

$${a}_{i} = \frac{1}{{Ω}_{serom} [ i , : ] {Ω}_{serom}^{H} [ i , : ]} \qquad ( 3 )$$

where Ωₛₑᵣₒₘ[i,:]∈ [symbol] ^{1×Q} denotes the i^{th} row of Ωₛₑᵣₒₘ. So, if the (i,j)^{th} entry of ΩₛₑᵣₒₘΩₛₑᵣₒₘ^{H} is denoted by bᵢⱼ, then, the (i,j)^{th} entry of ΩₛₑᵣₒₘΩₛₑᵣₒₘ^{H}diag[α₁, α₂, . . . , α_{L}] is

$$\{ \begin{matrix}1 , & if i = j \\ {b}_{ij} / {a}_{j} & otherwise\end{matrix} .$$

Since, bᵢⱼ≠0, SEROM entails a loss compared to ZF, but has the advantage of using Q<L time instants for channel estimation. Note that the case Q=L corresponds to ZF.

### 3. Described Technique

The motivation behind the herein described technique is that while ZF is the best one can do, the overhead is simply too high (a training period of L time instants). On the other hand, the RIS configuration matrix in SEROM, which is the truncated DFT matrix, is not proven to be optimal by mathematical means. The goal is to enhance the results by optimizing the matrix Ωₛₑᵣₒₘ using ML.

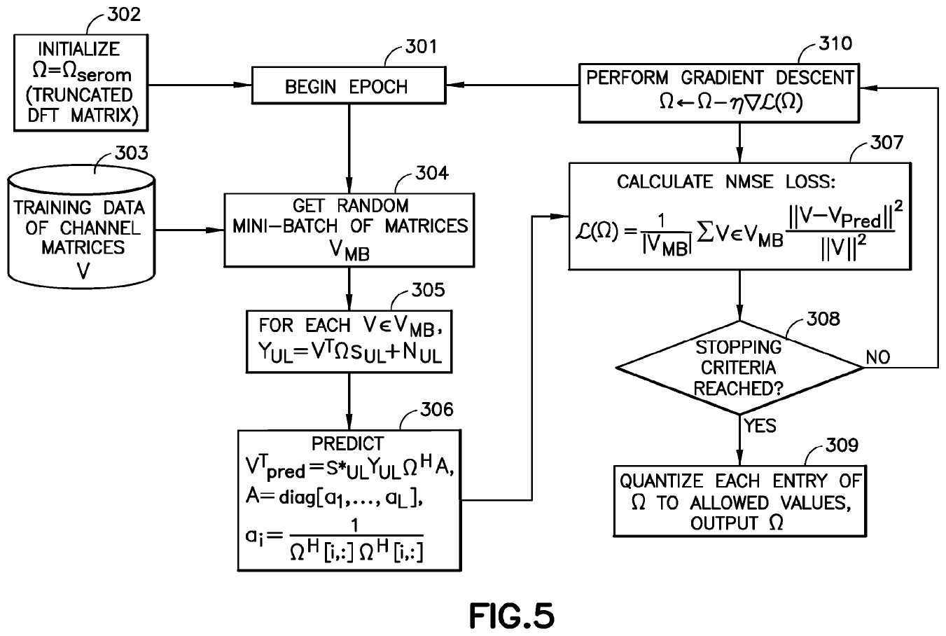

The flowchart of the herein described technique is illustrated in FIG. 5. In particular, the steps for learning the matrix Ω which fixes the RIS configuration for channel estimation are given as follows.
1. Choose a value of Q<L time instants that are used for channel estimation.
2. At 302, initialize the matrix Ω∈ [symbol] ^{L×Q} to the predefined value of the truncated DFT matrix.
3. Use a dataset of cascaded channel matrices V. As shown in FIG. 5, item 303 is the training data of channel matrices V.
4. At 304, in each epoch, a random mini-batch of channel matrices [symbol] _{MB} is selected. At 301, the epoch begins.
5. At 305, for each V∈ [symbol] _{MB}, generate Y_{UL}=V^{T}Ωs_{UL}+N_{UL}, where s_{UL} is a known unit-energy pilot signal, and N_{UL} is AWGN.
6. At 306, predict in each instance V_{pred}^{T}=s_{UL}*Y_{UL}Ω^{H}A, where A=diag[α₁, . . . , α_{L}] with

$${a}_{i} = \frac{1}{{Ω}^{H} [ i , : ] {Ω}^{H} [ i , : ]} .$$

7. At 307, compute the NMSE for the mini-batch as

$$ℒ ( Ω ) = \frac{1}{‖ {𝕍}_{MB} ‖} {\sum }_{V ∈ {𝕍}_{MB}} \frac{{‖ V - {V}_{Pred} ‖}^{2}}{{‖ V ‖}^{2}} .$$

8. If the stopping criteria is reached (e.g. “Yes” is determined at 308 such that the stopping criteria is reached), at 309 each entry of Ω is quantized to the nearest permissible value. Otherwise (e.g. “No” is determined at 308 such that the stopping criteria is not reached), at 310 a gradient descent update on Ω is performed and a new epoch begins at 301.

Once the training is performed, the method uses the chosen configuration for channel estimation at runtime. If necessary, the configuration can be retrained at regular intervals.

### 4. Simulation Results

QuaDRiGa (QUAsi Deterministic RadIo channel GenerAtor) is a channel simulator coded in Matlab. It is a statistical ray-tracing model and is developed essentially to enable the modeling of MIMO radio channels after specifying the exact network configurations from a set of predefined parameters. Using QuaDRiGa not only an outdoor wireless environment can be simulated, but also indoor, satellite, or any heterogeneous configurations can be simulated.

As RIS is a promising technology in densely populated urban areas, the 3GPP 38.901 UMi model was used. In this model, the maximum cell radius is about 200 m, the BS height is 10 m, and the UE height can vary between 1.5 and 22.5 m. The number of clusters (paths) is set to be 12. For each cluster, there are 20 subpaths. These sub-paths originate from the unresolvable paths that can still arrive from slightly different directions in the same scattering cluster but cannot be resolved in the delay domain. This added value to the model causes some fluctuations in the received power of the resolved paths as a result of the constructive and destructive interference caused by the superposition of these unresolvable paths. Table 1 shows the considered parameters for the channel simulation.

TABLE 1
Considered parameters for 3GPP 38.901 UMi Channel

| Parameter | Value | |
|---|---|---|
| Model | 3GPP 38.901 UMi | |
| Number of clusters | 12 | |
| Number of sub-paths | 20 | |
| per cluster | | |
| Cell radius | 200 | m |
| f_{c} | 3 | GHz |
| BS height | 10 | m |
| UE height | 1.5 | m |

| | |
|---|---|
| Oversampling factor | 32 |

The term f_{c} corresponds to the channel frequency. For a batch of 10,000 users, the propagation of the wave in the predefined channel was simulated. Then, the path coefficient for each user's LOS path was extracted with the relative distance from the BS.

In order to extract an accurate model, the examples herein consider linear regression fitting. Then, the variance of the power is derived for each distance, averaging over each distance. It was found that the values fluctuate between −10 dB and 10 dB. The used linear model is

$$Power [ dBm ] = - 20.498 {d}_{UE - BS} [ m ] - 13.939 \qquad ( 2 )$$

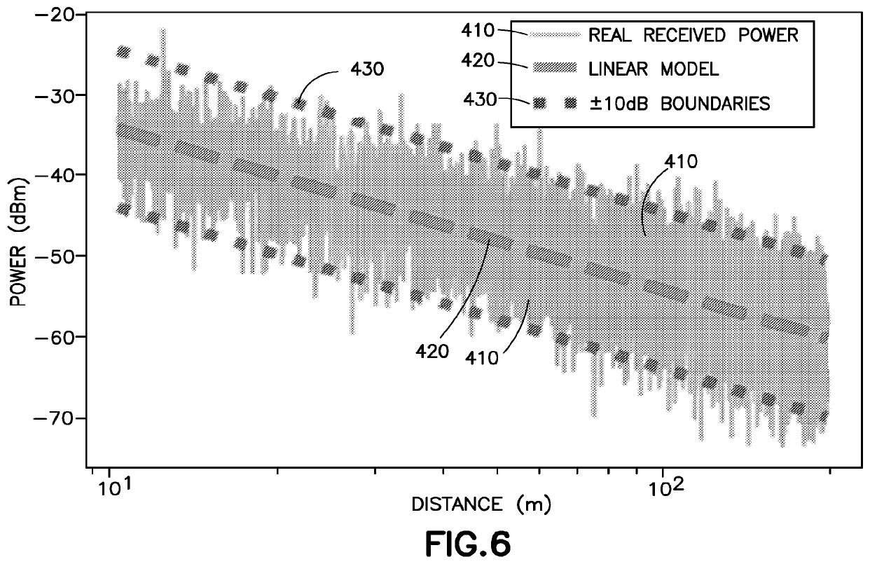

FIG. 6 presents the plot of the power decay versus the distance between the transmitters (UE 110) and the BS 170 with the linear regression model and the variance of the model around the mean value. The real received power is shown at 410, the linear model is shown as 420, and the +10 dB boundaries are shown as 430.

After the linear regression, the extracted model is used in the simulations. To do so, the extracted model is considered/used to calculate the mean value of the power for each distance between the UE and BS varying from 10 to 200 m. After that, as the fluctuations are between −10 dB and +10 dB, a normal distribution is considered with the mean being the mean value from the linear model. For the variance σ², it is known well that for any normal distribution more than 95% of the values are between −3σ and +3σ. So, 6σ=20 dB and σ=3.33 dB.

The simulation results were presented to validate the herein described technique for RIS-enhanced SISO systems. Simulations have confirmed that with a reasonable number of pilots, the method described herein outperforms the original SEROM algorithm with a better NMSE.

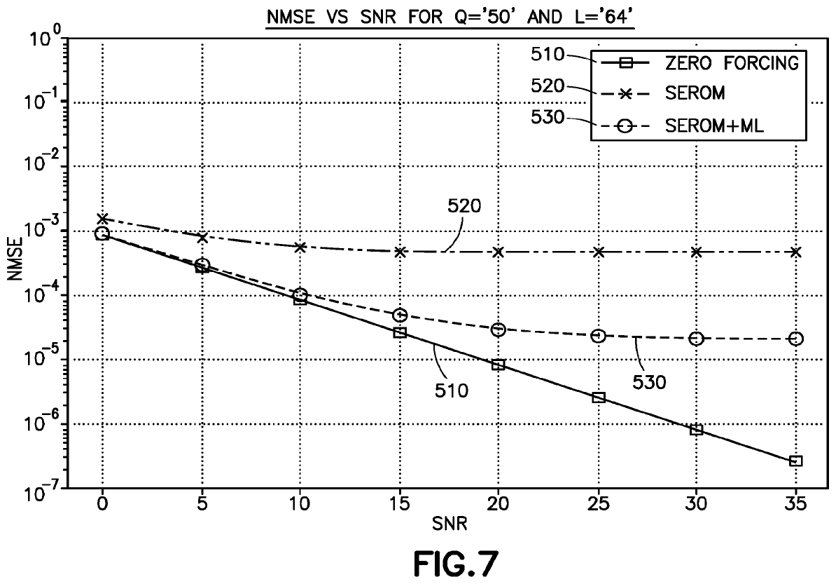

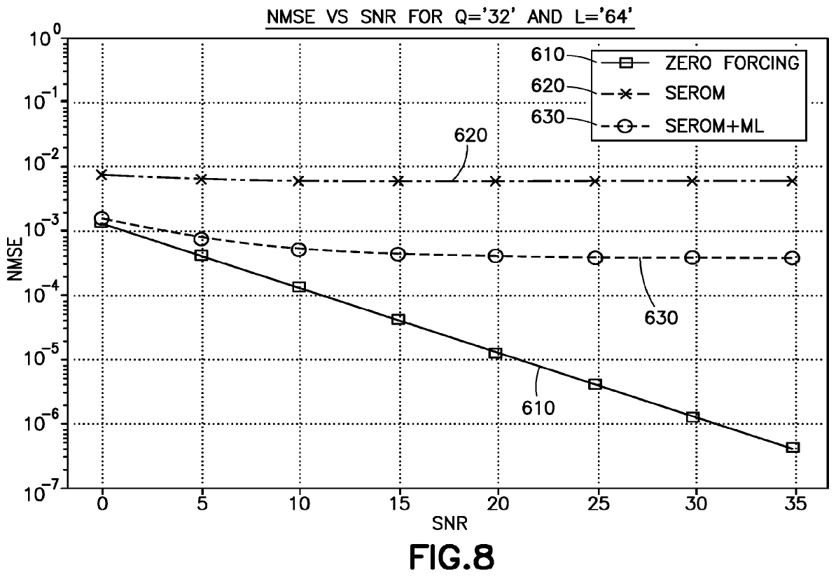

The number of RIS element are set to be L=8*8=64 elements. For the number of time instants used for channel estimation, Q=32 and Q=50 are used respectively. FIGS. 7 and 8 plot the results for Q=50 and Q=32 respectively, where the plots are for ZF (510, 610), SEROM (520, 620), and the herein described technique (530, 630). As ZF is optimal and unbeatable, it can be clearly seen for Q=50 in FIG. 7 that the ML-based method achieves near optimal results up to an NMSE of 10⁻⁴ with a remarkable gain over the original SEROM method. Further, in FIG. 8, it can be seen that the gain of the ML-based method is still remarkable over the SEROM algorithm for Q=32. However, the performance in terms of NMSE is not as good as in the previous case due to the lower overhead used for channel estimation.

There is definitely a lot of interest on this topic in the telecommunications community given the current research about RIS. It is strongly believed that the herein described examples/methods are to be an important addition to ML-based products/solutions.

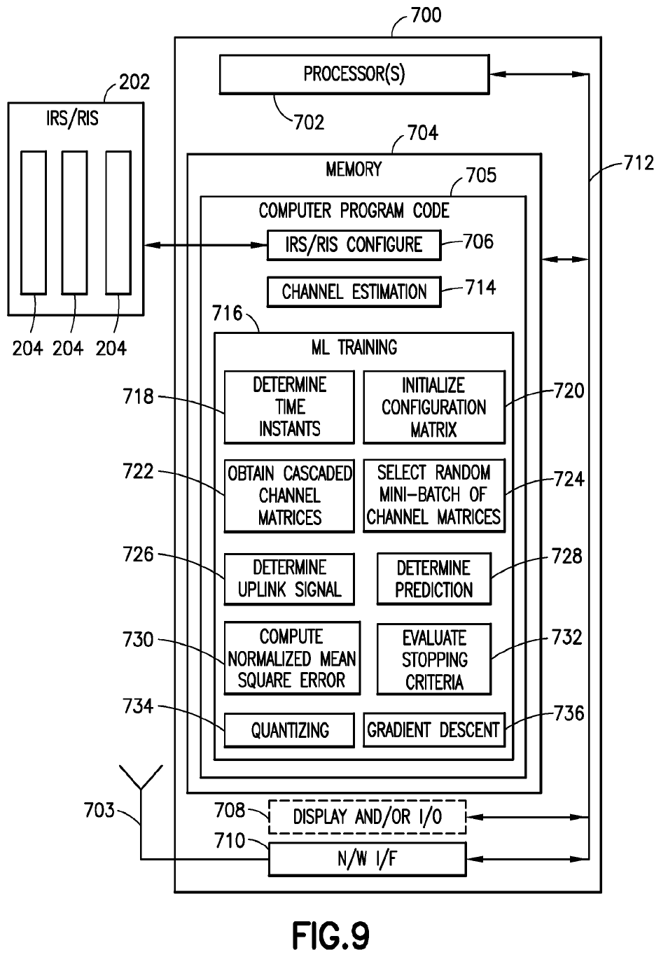

FIG. 9 is an example apparatus 700, which may be implemented in hardware, configured to implement the examples described herein. The apparatus 700 comprises at least one processor 702 (e.g. an FPGA and/or CPU), at least one memory 704 including computer program code 705, wherein at least one memory 704 and the computer program code 705 are configured to, with at least one processor 702, cause the apparatus 700 to implement circuitry, a process, component, module, or function to implement the examples described herein, including a method for machine-learning-based uplink channel estimation in reflective intelligent systems. The memory 704 may be a non-transitory memory, a transitory memory, a volatile memory, or a non-volatile memory.

The apparatus 700 optionally includes a display and/or I/O interface 708 that may be used to display aspects or a status of the methods described herein (e.g., as one of the methods is being performed or at a subsequent time), or to receive input from a user such as with using a keypad, touchscreen, touch areas, microphone, etc. The apparatus 700 includes one or more network (N/W) interfaces (I/F(s)) 710 coupled to one or more antennae 703. The N/W I/F(s) 710 may be wired and/or wireless and communicate over the Internet/other network(s) via any communication technique. The N/W I/F(s) 710 may comprise one or more transmitters and one or more receivers. The N/W I/F(s) 710 may comprise standard well-known components such as an amplifier, filter, frequency-converter, (de) modulator, and encoder/decoder circuitries and one or more antennas.

The apparatus 700 to implement the functionality of IRS/RIS configure 706 may be IRS controller 210, UE 110, RAN node 170, network element(s) 190. Thus, processor 702 may correspond respectively to processor(s) 120, processor(s) 152 and/or processor(s) 175, memory 704 may correspond respectively to memory(ies) 125, memory(ies) 155 and/or memory(ies) 171, computer program code 705 may correspond respectively to computer program code 123, module 140-1, module 140-2, and/or computer program code 153, module 150-1, module 150-2, and/or computer program code 173, and N/W I/F(s) 710 may correspond respectively to N/W I/F(s) 161 and/or N/W I/F(s) 180. Alternatively, apparatus 700 may not correspond to either of IRS controller 210, UE 110, RAN node 170, or network element(s) 190, as apparatus 700 may be part of a self-organizing/optimizing network (SON) node, such as in a cloud.

The apparatus 700 may also be distributed throughout the network (e.g. 100) including within and between apparatus 700 and any network element (such as a network control element (NCE) 190 and/or the RAN node 170 and/or the UE 110).

Interface 712 enables data communication between the various items of apparatus 700, as shown in FIG. 9. For example, the interface 712 may be one or more buses such as address, data, or control buses, and may include any interconnection mechanism, such as a series of lines on a motherboard or integrated circuit, fiber optics or other optical communication equipment, and the like. Computer program code 705, including IRS/configure 706 may comprise object-oriented software configured to pass data/messages between objects within computer program code 705. The apparatus 700 need not comprise each of the features mentioned, or may comprise other features as well.

The at least one memory 704 and the computer program code 705 are configured to, with the at least one processor 702, cause the apparatus 700 at least to: train a machine learning model to learn a configuration matrix that defines a reconfigurable intelligent surface 202 (using 716), configure the reconfigurable intelligent surface 202 for channel estimation during runtime, using the learned configuration matrix (using 706), perform channel estimation on an uplink channel 275 (refer to FIG. 2) using the reconfigurable intelligent surface 202 (using 714), and reconfigure the reconfigurable intelligent surface 202 after the channel estimation to improve coverage within the uplink channel 275 (using 706).

Training the machine learning model 716 using the apparatus 700 comprises determining a number of time instants, the number of time instants being less than a number of elements 204 within the reconfigurable intelligent surface 202 (using 718), initializing the configuration matrix to be a truncated discrete Fourier transform matrix (using 720), obtaining a dataset of a plurality of cascaded channel matrices (using 722), selecting, in an epoch, a random mini-batch of channel matrices (using 724), determining a received uplink signal corresponding to one of the cascaded channel matrices within the random mini-batch of channel matrices (using 726), determining a prediction of the one of the cascaded channel matrices (using 728), computing a normalized mean square error for the mini-batch (using 730), determining whether a stopping criterion is reached (using 732), in response to the stopping criterion being reached, quantizing the entries of the configuration matrix to a nearest permissible value (using 734), and in response to the stopping criterion not being reached, performing a gradient descent on the configuration matrix and beginning a new epoch (using 736).

Stated another way, training the machine learning model 716 using the apparatus 700 comprises determining a number of time instants Q, the number of time instants Q being less than a number of elements L 204 within the reconfigurable intelligent surface 202 (using 718); initializing the configuration matrix Ω∈ [symbol] ^{L×Q} to be a truncated discrete Fourier transform matrix, where [symbol] comprises a complex analytic space, where the operator ∈ denotes within (using 720); obtaining a dataset of a plurality of cascaded channel matrices V (using 722); selecting, in each epoch, a random mini-batch of channel matrices [symbol] _{MB} (using 724); determining, for each V∈ [symbol] _{MB}, a received uplink signal Y_{UL}=V^{T}Ωs_{UL}+N_{UL}, where s_{UL} is a known unit-energy pilot signal, N_{UL} is additive white Gaussian noise, UL corresponds to uplink, and T corresponds to a sequence of pilot signals (using 726); determining a prediction in each instance V_{pred}^{T}=s_{UL}*Y_{UL}Ω^{H}A, where A=diag[α₁, . . . , α_{L}] with

$${a}_{i} = \frac{1}{{Ω}^{H} [ i , : ] {Ω}^{H} [ i , : ]} ,$$

where * corresponds to a conjugate transpose, i is chosen among 1 to L, and where diag corresponds to a diagonal of a matrix (using 728); computing a normalized mean square error for the mini-batch as

$$ℒ ( Ω ) = \frac{1}{‖ {𝕍}_{MB} ‖} {\sum }_{V ∈ {𝕍}_{MB}} \frac{{‖ V - {V}_{Pred} ‖}^{2}}{{‖ V ‖}^{2}} ,$$

where operator ∥ corresponds to an absolute value, and where operator ∥ ∥ corresponds to a norm (using 730); determining whether a stopping criterion is reached (using 732); in response to the stopping criterion being reached, quantizing the entries of the configuration matrix Ω to a nearest permissible value (using 734); and in response to the stopping criterion not being reached, performing a gradient descent on the configuration matrix Ω and beginning a new epoch, where during the gradient descent the configuration matrix Ω is updated to be Ω−η∇ [symbol] (Ω), where η comprises a learning rate, and ∇ denotes a gradient operation (using 736).

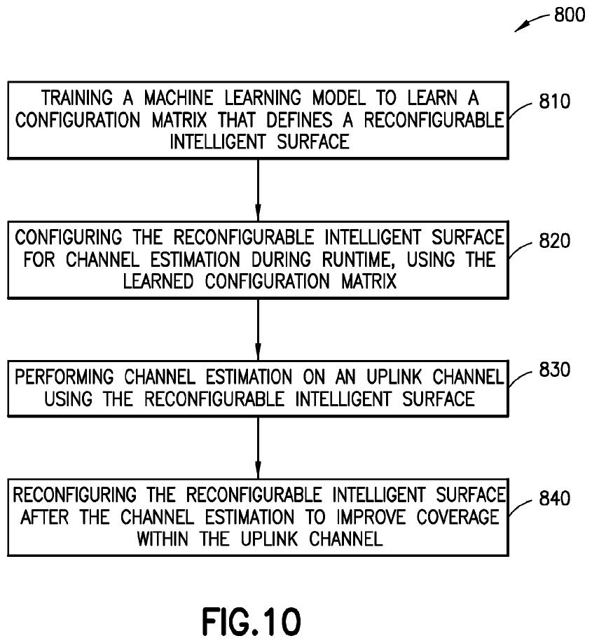

FIG. 10 is an example method 800 to implement the example embodiments described herein. At 810, the method includes training a learning machine model to learn a configuration matrix that defines a reconfigurable intelligent surface. At 820, the method includes configuring the reconfigurable intelligent surface for channel estimation during runtime, using the learned configuration matrix. At 830, the method includes performing channel estimation on an uplink channel using the reconfigurable intelligent surface. At 840, the method includes reconfiguring the reconfigurable intelligent surface after the channel estimation to improve coverage within the uplink channel. Method 800 may be performed by network element(s) 190, apparatus 700, RAN node 170, or UE 110.

References to a ‘computer’, ‘processor’, etc. should be understood to encompass not only computers having different architectures such as single/multi-processor architectures and sequential or parallel architectures but also specialized circuits such as field-programmable gate arrays (FPGAs), application specific circuits (ASICs), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

The memory(ies) as described herein may be implemented using any suitable data storage technology, such as semiconductor based memory devices, flash memory, magnetic memory devices and systems, optical memory devices and systems, non-transitory memory, transitory memory, fixed memory and removable memory. The memory(ies) may comprise a database for storing data.

As used herein, the term ‘circuitry’ may refer to the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. As a further example, as used herein, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

The following examples (1-36) are provided and described herein.
Example 1: An apparatus includes at least one processor; and at least one memory including computer program code; wherein the at least one memory and the computer program code are configured to, with the at least one processor, cause the apparatus at least to: train a machine learning model to learn a configuration matrix that defines a reconfigurable intelligent surface; configure the reconfigurable intelligent surface for channel estimation during runtime, using the learned configuration matrix; perform channel estimation on an uplink channel using the reconfigurable intelligent surface; and reconfigure the reconfigurable intelligent surface after the channel estimation to improve coverage within the uplink channel.
Example 2: The apparatus of example 1, wherein the uplink channel comprises a cascaded uplink channel from a user equipment to the reconfigurable intelligent surface, and then from the reconfigurable intelligent surface to a network node.
Example 3: The apparatus of any of examples 1 to 2, wherein training the machine learning model comprises meeting a target normalized mean square error for at least one channel coefficient estimate.
Example 4: The apparatus of any of examples 1 to 3, wherein the reconfigurable intelligent surface comprises a plurality of passive elements without a radio frequency part.
Example 5: The apparatus of any of examples 1 to 4, wherein the at least one memory and the computer program code are configured to, with the at least one processor, cause the apparatus at least to: retrain the machine learning model at regular intervals.
Example 6: The apparatus of any of examples 1 to 5, wherein training the machine learning model comprises: determining a number of time instants, the number of time instants being less than a number of elements within the reconfigurable intelligent surface.
Example 7: The apparatus of example 6, wherein training the machine learning model further comprises: initializing the configuration matrix to be a truncated discrete Fourier transform matrix.
Example 8: The apparatus of example 7, wherein the configuration matrix is initialized to comprise a dimension corresponding to the number of time instants and the number of elements within the reconfigurable intelligent surface, and to comprise a complex analytical space.
Example 9: The apparatus of any of examples 7 to 8, wherein training the machine learning model further comprises: obtaining a dataset of a plurality of cascaded channel matrices.
Example 10: The apparatus of example 9, wherein training the machine learning model further comprises: selecting, in an epoch, a random mini-batch of channel matrices.
Example 11: The apparatus of example 10, wherein training the machine learning model further comprises: determining a received uplink signal corresponding to one of the cascaded channel matrices within the random mini-batch of channel matrices.
Example 12: The apparatus of example 11, wherein the received uplink signal is generated as a product of the one of the cascaded channel matrices, the configuration matrix, and a unit-energy pilot signal, the product added to an additive white Gaussian noise of the channel.
Example 13: The apparatus of example 12, wherein the one of the cascaded channel matrices has a dimension corresponding to a sequence of pilot signals.
Example 14: The apparatus of any of examples 11 to 13, wherein training the machine learning model further comprises: determining a prediction of the one of the cascaded channel matrices.
Example 15: The apparatus of example 14, wherein the prediction of the one of the cascaded channel matrices is determined as an instance product of an element-wise conjugate of a unit-energy pilot signal, the received uplink signal, a conjugate transpose of the configuration matrix, and a diagonal matrix of scaling factors, where a number of the scaling factors corresponds to the number of elements within the reconfigurable intelligent surface.
Example 16: The apparatus of example 15, wherein the at least one memory and the computer program code are further configured to, with the at least one processor, cause the apparatus at least to: determine one of the scaling factors as a reciprocal of a scaling product of a corresponding element of the conjugate transpose of the configuration matrix and the corresponding element of the conjugate transpose of the configuration matrix.
Example 17: The apparatus of any of examples 14 to 16, wherein training the machine learning model further comprises: computing a normalized mean square error for the mini-batch.
Example 18: The apparatus of example 17, wherein the normalized mean square error for the mini-batch is computed as a mini-batch product of a reciprocal of an absolute value of the channel matrices, and a sum over the cascaded channel matrices within the random mini-batch of channel matrices of a squared norm of a difference between one of the cascaded channel matrices and the prediction of the one of the cascaded channel matrices divided with a squared norm of the one of the cascaded channel matrices.
Example 19: The apparatus of any of examples 17 to 18, wherein training the machine learning model further comprises: determining whether a stopping criterion is reached.
Example 20: The apparatus of example 19, wherein training the machine learning model further comprises: in response to the stopping criterion being reached, quantizing the entries of the configuration matrix to a nearest permissible value.
Example 21: The apparatus of any of examples 19 to 20, wherein training the machine learning model further comprises: in response to the stopping criterion not being reached, performing a gradient descent on the configuration matrix and beginning a new epoch.
Example 22: The apparatus of any of examples 1 to 21, wherein training the machine learning model comprises: determining a number of time instants, the number of time instants being less than a number of elements within the reconfigurable intelligent surface; initializing the configuration matrix to be a truncated discrete Fourier transform matrix; obtaining a dataset of a plurality of cascaded channel matrices; selecting, in an epoch, a random mini-batch of channel matrices; determining a received uplink signal corresponding to one of the cascaded channel matrices within the random mini-batch of channel matrices; determining a prediction of the one of the cascaded channel matrices; computing a normalized mean square error for the mini-batch; determining whether a stopping criterion is reached; in response to the stopping criterion being reached, quantizing the entries of the configuration matrix to a nearest permissible value; and in response to the stopping criterion not being reached, performing a gradient descent on the configuration matrix and beginning a new epoch.
Example 23: The apparatus of any of examples 1 to 22, wherein training the machine learning model comprises: determining a number of time instants Q, the number of time instants Q being less than a number of elements L within the reconfigurable intelligent surface.
Example 24: The apparatus of example 23, wherein training the machine learning model further comprises: initializing the configuration matrix Ω∈ [symbol] ^{L×Q} to be a truncated discrete Fourier transform matrix, where [symbol] comprises a complex analytic space, where the operator ∈ denotes within.
Example 25: The apparatus of example 24, wherein training the machine learning model further comprises: obtaining a dataset of a plurality of cascaded channel matrices V.
Example 26: The apparatus of example 25, wherein training the machine learning model further comprises: selecting, in each epoch, a random mini-batch of channel matrices [symbol] _{MB}.
Example 27: The apparatus of example 26, wherein training the machine learning model further comprises: determining, for each V∈ [symbol] _{MB}, a received uplink signal Y_{UL}=V^{T}Ωs_{UL}+N_{UL}, where s_{UL} is a known unit-energy pilot signal, N_{UL} is additive white Gaussian noise, UL corresponds to uplink, and T corresponds to a sequence of pilot signals.
Example 28: The apparatus of example 27, wherein training the machine learning model further comprises: determining a prediction in each instance V_{pred}^{T}=s_{UL}Y_{UL}Ω^{H}A, where A=diag[α₁, . . . , α_{L}] with

$${a}_{i} = \frac{1}{{Ω}^{H} [ i , : ] {Ω}^{H} [ i , : ]} ,$$

where * corresponds to element-wise conjugate, where H corresponds to a conjugate transpose, i is chosen among 1 to L, and where diag corresponds to a diagonal of a matrix
Example 29: The apparatus of example 28, wherein training the machine learning model further comprises: computing a normalized mean square error for the mini-batch as

$$ℒ ( Ω ) = \frac{1}{‖ {𝕍}_{MB} ‖} {\sum }_{V ∈ {𝕍}_{MB}} \frac{{‖ V - {V}_{Pred} ‖}^{2}}{{‖ V ‖}^{2}} ,$$

where operator ∥ corresponds to an absolute value, and where operator ∥ ∥ corresponds to a norm.
Example 30: The apparatus of example 29, wherein training the machine learning model further comprises: determining whether a stopping criterion is reached.
Example 31: The apparatus of example 30, wherein training the machine learning model further comprises: in response to the stopping criterion being reached, quantizing the entries of the configuration matrix Ω to a nearest permissible value.
Example 32: The apparatus of any of examples 30 to 31, wherein training the machine learning model further comprises: in response to the stopping criterion not being reached, performing a gradient descent on the configuration matrix Ω and beginning a new epoch, where during the gradient descent the configuration matrix Ω is updated to be Ω−η∇ [symbol] (Ω), where η comprises a learning rate, and ∇ denotes a gradient operation.
Example 33: The apparatus of any of examples 1 to 32, wherein training the machine learning model comprises: determining a number of time instants Q, the number of time instants Q being less than a number of elements L within the reconfigurable intelligent surface; initializing the configuration matrix Ω∈ [symbol] ^{L×Q} to be a truncated discrete Fourier transform matrix, where [symbol] comprises a complex analytic space, where the operator ∈ denotes within; obtaining a dataset of a plurality of cascaded channel matrices V; selecting, in each epoch, a random mini-batch of channel matrices [symbol] _{MB}; determining, for each V∈ [symbol] _{MB}, a received uplink signal Y_{UL}=V^{T}Ωs_{UL}+N_{UL}, where s_{UL} is a known unit-energy pilot signal, N_{UL} is additive white Gaussian noise, UL corresponds to uplink, and T corresponds to a sequence of pilot signals; determining a prediction in each instance V_{pred}^{T}=s_{UL}*Y_{UL}Ω^{H}A, where A=diag[α₁, . . . , α_{L}] with

$${a}_{i} = \frac{1}{{Ω}^{H} [ i , : ] {Ω}^{H} [ i , : ]} ,$$

where * corresponds to element-wise conjugate, where H corresponds to a conjugate transpose, i is chosen among 1 to L, and where diag corresponds to a diagonal of a matrix; computing a normalized mean square error for the mini-batch as

$$ℒ ( Ω ) = \frac{1}{‖ {𝕍}_{MB} ‖} {\sum }_{V ∈ {𝕍}_{MB}} \frac{{‖ V - {V}_{Pred} ‖}^{2}}{{‖ V ‖}^{2}} ,$$

where operator ∥ corresponds to an absolute value, and where operator ∥ ∥ corresponds to a norm; determining whether a stopping criterion is reached; in response to the stopping criterion being reached, quantizing the entries of the configuration matrix Ω to a nearest permissible value; and in response to the stopping criterion not being reached, performing a gradient descent on the configuration matrix Ω and beginning a new epoch, where during the gradient descent the configuration matrix Ω is updated to be Ω−η∇ [symbol] (Ω), where η comprises a learning rate, and ∇ denotes a gradient operation.
Example 34: A method includes training a machine learning model to learn a configuration matrix that defines a reconfigurable intelligent surface; configuring the reconfigurable intelligent surface for channel estimation during runtime, using the learned configuration matrix; performing channel estimation on an uplink channel using the reconfigurable intelligent surface; and reconfiguring the reconfigurable intelligent surface after the channel estimation to improve coverage within the uplink channel.
Example 35: An apparatus includes means for training a machine learning model to learn a configuration matrix that defines a reconfigurable intelligent surface; means for configuring the reconfigurable intelligent surface for channel estimation during runtime, using the learned configuration matrix; means for performing channel estimation on an uplink channel using the reconfigurable intelligent surface; and means for reconfiguring the reconfigurable intelligent surface after the channel estimation to improve coverage within the uplink channel.
Example 36: A non-transitory program storage device readable by a machine, tangibly embodying program of instructions executable with the machine for performing operations, the operations comprising: training a machine learning model to learn a configuration matrix that defines a reconfigurable intelligent surface; configuring the reconfigurable intelligent surface for channel estimation during runtime, using the learned configuration matrix; performing channel estimation on an uplink channel using the reconfigurable intelligent surface; and reconfiguring the reconfigurable intelligent surface after the channel estimation to improve coverage within the uplink channel.

It should be understood that the foregoing description is only illustrative. Various alternatives and modifications may be devised by those skilled in the art. For example, features recited in the various dependent claims could be combined with each other in any suitable combination(s). In addition, features from different embodiments described above could be selectively combined into a new embodiment. Accordingly, this description is intended to embrace all such alternatives, modifications and variances which fall within the scope of the appended claims.

The following acronyms and abbreviations that may be found in the specification and/or the drawing figures are defined as follows (the abbreviations and acronyms may be appended with each other or with other characters using e.g. a dash or hyphen):
3D three-dimensional
3GPP third generation partnership project
4G fourth generation
5G fifth generation
5GC 5G core network
AMF access and mobility management function
AP access point
ASIC application-specific integrated circuit
AWGN additive white Gaussian noise
BS base station
CU central unit or centralized unit
DFT discrete Fourier transform
DSP digital signal processor
DU distributed unit
E2E end-to-end
eNB evolved Node B (e.g., an LTE base station)
EN-DC E-UTRA-NR dual connectivity
en-gNB node providing NR user plane and control plane protocol terminations towards the UE, and acting as a secondary node in EN-DC
E-UTRA evolved universal terrestrial radio access, i.e., the LTE radio access technology
F1 interface between the CU and the DU
FPGA field-programmable gate array
gNB base station for 5G/NR, i.e., a node providing NR user plane and control plane protocol terminations towards the UE, and connected via the NG interface to the 5GC
I/F interface
I/O input/output
IRS intelligent reflective surfaces
LMF location management function
LOS line of sight
LTE long term evolution (4G)
MAC medium access control MAC
MB mini-batch
MIMO multiple-input multiple-output
miso multiple input single output
ML machine learning
MME mobility management entity
NCE network control element
ng or NG new generation
ng-eNB new generation eNB
NG-RAN new generation radio access network
NMSE normalized mean square error
N/W network
OFDM orthogonal frequency-division multiplexing
PDA personal digital assistant
PDCP packet data convergence protocol
PHY physical layer
prop propagation
QuaDRiGa quasi deterministic radio channel generator
RAN radio access network
RF radio frequency
RIS or ris reconfigurable intelligent surface(s)
RLC radio link control
RRC radio resource control (protocol)
RU radio unit
Rx receiver or reception
SEROM single emphasis on rank one matrix
SGW serving gateway
SISO single-input single-output
SNR signal-to-noise ratio
SON self-organizing/optimizing network
TRP transmission and/or reception point
Tx transmitter or transmission
UE user equipment (e.g., a wireless, typically mobile device)
UL uplink
UMi 3D-urban micro channel model
UPF user plane function
X2 network interface between RAN nodes and between RAN and the core network
Xn network interface between NG-RAN nodes
ZF zero forcing

1. An apparatus comprising:
at least one processor; and
at least one memory including computer program code;
wherein the at least one memory and the computer program code are configured to, with the at least one processor, cause the apparatus at least to:
train a machine learning model to learn a configuration matrix that defines a reconfigurable intelligent surface;
configure the reconfigurable intelligent surface for channel estimation during runtime, using the learned configuration matrix;
perform channel estimation on an uplink channel using the reconfigurable intelligent surface; and
reconfigure the reconfigurable intelligent surface after the channel estimation to improve coverage within the uplink channel.

2. The apparatus of claim 1, wherein the uplink channel comprises a cascaded uplink channel from a user equipment to the reconfigurable intelligent surface, and then from the reconfigurable intelligent surface to a network node.

3. The apparatus of claim 1, wherein training the machine learning model comprises meeting a target normalized mean square error for at least one channel coefficient estimate.

4. The apparatus of claim 1, wherein the reconfigurable intelligent surface comprises a plurality of passive elements without a radio frequency part.

5. (canceled)

6. The apparatus of claim 1, wherein training the machine learning model comprises:
determining a number of time instants, the number of time instants being less than a number of elements within the reconfigurable intelligent surface.

7. The apparatus of claim 6, wherein training the machine learning model further comprises:
initializing the configuration matrix to be a truncated discrete Fourier transform matrix;
obtaining a dataset of a plurality of cascaded channel matrices;
selecting, in an epoch, a random mini-batch of channel matrices; and
determining a received uplink signal corresponding to one of the cascaded channel matrices within the random mini-batch of channel matrices.

8. The apparatus of claim 7, wherein the configuration matrix is initialized to comprise a dimension corresponding to the number of time instants and the number of elements within the reconfigurable intelligent surface, and to comprise a complex analytical space.

9-11. (canceled)

12. The apparatus of claim 7, wherein the received uplink signal is generated as a product of the one of the cascaded channel matrices, the configuration matrix, and a unit-energy pilot signal, the product added to an additive white Gaussian noise of the channel, and wherein the one of the cascaded channel matrices has a dimension corresponding to a sequence of pilot signals.

13. (canceled)

14. The apparatus of claim 7, wherein training the machine learning model further comprises:
determining a prediction of the one of the cascaded channel matrices, and wherein the prediction of the one of the cascaded channel matrices is determined as an instance product of an element-wise conjugate of a unit-energy pilot signal, the received uplink signal, a conjugate transpose of the configuration matrix, and a diagonal matrix of scaling factors, where a number of the scaling factors corresponds to the number of elements within the reconfigurable intelligent surface.

15. (canceled)

16. The apparatus of claim 7, wherein the at least one memory and the computer program code are further configured to, with the at least one processor, cause the apparatus at least to:
determine one of the scaling factors as a reciprocal of a scaling product of a corresponding element of the conjugate transpose of the configuration matrix and the corresponding element of the conjugate transpose of the configuration matrix.

17. The apparatus of claim 14, wherein training the machine learning model further comprises:
computing a normalized mean square error for the mini-batch.

18. The apparatus of claim 17, wherein the normalized mean square error for the mini-batch is computed as a mini-batch product of a reciprocal of an absolute value of the channel matrices, and a sum over the cascaded channel matrices within the random mini-batch of channel matrices of a squared norm of a difference between one of the cascaded channel matrices and the prediction of the one of the cascaded channel matrices divided with a squared norm of the one of the cascaded channel matrices.

19. The apparatus of claim 17, wherein training the machine learning model further comprises:
determining whether a stopping criterion is reached.

20. The apparatus of claim 19, wherein training the machine learning model further comprises:
in response to the stopping criterion being reached, quantizing the entries of the configuration matrix to a nearest permissible value.

21. The apparatus of claim 19, wherein training the machine learning model further comprises:
in response to the stopping criterion not being reached, performing a gradient descent on the configuration matrix and beginning a new epoch.

22. The apparatus of claim 1, wherein training the machine learning model comprises:
determining a number of time instants, the number of time instants being less than a number of elements within the reconfigurable intelligent surface;
initializing the configuration matrix to be a truncated discrete Fourier transform matrix;
obtaining a dataset of a plurality of cascaded channel matrices;
selecting, in an epoch, a random mini-batch of channel matrices;
determining a received uplink signal corresponding to one of the cascaded channel matrices within the random mini-batch of channel matrices;
determining a prediction of the one of the cascaded channel matrices;
computing a normalized mean square error for the mini-batch;
determining whether a stopping criterion is reached;
in response to the stopping criterion being reached, quantizing the entries of the configuration matrix to a nearest permissible value; and
in response to the stopping criterion not being reached, performing a gradient descent on the configuration matrix and beginning a new epoch.

23-33. (canceled)

34. A method comprising:
training a machine learning model to learn a configuration matrix that defines a reconfigurable intelligent surface;
configuring the reconfigurable intelligent surface for channel estimation during runtime, using the learned configuration matrix;
performing channel estimation on an uplink channel using the reconfigurable intelligent surface; and
reconfiguring the reconfigurable intelligent surface after the channel estimation to improve coverage within the uplink channel.

35. (canceled)

36. A non-transitory program storage device readable by a machine, tangibly embodying a program of instructions executable with the machine for performing operations, the operations comprising:
training a machine learning model to learn a configuration matrix that defines a reconfigurable intelligent surface;
configuring the reconfigurable intelligent surface for channel estimation during runtime, using the learned configuration matrix;
performing channel estimation on an uplink channel using the reconfigurable intelligent surface; and
reconfiguring the reconfigurable intelligent surface after the channel estimation to improve coverage within the uplink channel.
